(19) United States
(12) Patent Application Publication
(10) Pub. No.: US 2017/0141638 A1
(43) Pub. Date: May 18, 2017

(54) Cordless oscillatory hand held apparatus

(71) Applicants: Philippe WOOG, Vesenaz (CH); Stephane BALSAT, Viuz-en-Sallaz (FR)

(72) Inventors: Philippe WOOG, Vesenaz (CH); Stephane BALSAT, Viuz-en-Sallaz (FR)

(21) Appl. No.: 14/938,912

(22) Filed: Nov. 12, 2015

(51) Int. Cl. H02K 5/04; H02K 11/00; H02K 7/14

(52) U.S. Cl. CPC H02K 5/04; H02K 7/145; H02K 11/0094

(57) ABSTRACT

A cordless oscillatory hand held apparatus, comprises a casing 1 enclosing a rotationally oscillatory wireless electric micro-motor operable by application of an AC current. The micro-motor comprises an electromagnetic stator and a rotor cooperating therewith, the rotor having a rotor shaft extending from the micro-motor through the casing 1. The casing 1 includes a compartment for housing a battery 50 to power said micro-motor to produce rotational oscillation of said rotor and rotor shaft, and further comprising a DC/AC converter 60 for converting DC current from a battery 50 in said compartment into an AC current applied to the electric micro-motor.

The present invention relates to a cordless oscillatory hand held apparatus, especially a toothbrush, a massage apparatus or an electric razor.

For example, the use of mechanical toothbrushes, typically those that are electrically driven, has been known for a number of years. The purpose, in any event, is to clean the teeth, usually with a toothbrush that comprises a plurality of bristles that are used in conjunction with a dentifrice. U.S. Pat. No. 2,917,758 substituted for the hand of the operator a mechanical much more efficient control providing a better result within a much shorter time since it was possible to obtain mechanical movements which were much more rapid and more accurately directed than those executed hitherto by hand. In fact, the applicant developed a motor which is an alternating current motor including an angularly reciprocating (rotationally oscillating) rotor imparting to the head of the brush a rocking movement round the axis of a shaft. Clinical studies have demonstrated that integrating such a motor in a toothbrush provides superior results in gingival health, dental health, periodontal health and safety.

A limitation of known toothbrushes and massage apparatus of the above type is that they are driven by an electric motor that is powered by an external mains AC power supply.

The invention aims at developing a cordless oscillatory hand held apparatus comprising an AC micro-motor operable by application of an AC current including an angularly reciprocating (rotationally oscillating) rotor that imparts to the head of a shaft a rocking movement around the axis of the shaft.

According to the invention, a cordless oscillatory hand held apparatus comprises a casing enclosing a rotationally oscillatory wireless electric micro-motor operable by application of an AC current. The micro-motor comprises an electromagnetic stator and a rotor cooperating therewith, the rotor having a rotor shaft extending from the micro-motor through the casing. The casing includes a compartment for housing a battery to power said micro-motor to produce rotational oscillation of said rotor and rotor shaft that imparts a rocking movement to the rotor shaft. The apparatus further comprises a DC/AC converter for converting DC current from a battery in said compartment into an AC current applied to the electric micro-motor.

In an embodiment, the micro-motor is adapted to oscillate synchronously at the AC frequency applied thereto, said DC/AC converter being arranged to energize the stator with alternating current at a frequency in the range of approximately 50 to 60 cycles per second to produce rotational oscillations of said rotor of corresponding frequency.

In another embodiment, the stator has a core comprising a pair of spaced legs extending longitudinally of said casing and a transverse section joining said legs near one end thereof, the rotor being mounted between the other ends of said legs on a rotor shaft extending longitudinally of said casing, the rotor shaft extending through one end of said casing.

According to this other embodiment, the other ends of said legs form pole sections substantially symmetrical with respect to a plane therethrough that extends longitudinally of said casing and further comprising a coil encircling said transverse section. The rotor is positioned between said pole sections, the rotor shaft mounting said rotor for rotation about an axis extending longitudinally of said casing and substantially in said plane of symmetry. The rotor includes a permanent magnet having magnetic poles on diametrically opposite sides of said axis and the rotor shaft extending through one end of said casing. Elastic means urge said rotor to a predetermined angular position in which a plane of substantial symmetry through said magnetic poles and through said axis is approximately perpendicular to said plane of symmetry of the stator pole sections, and the DC/AC converter is arranged to energize said stator coil with alternating current to produce rotational oscillation of said rotor.

The inner surfaces of said pole sections form portions of a cylindrical surface having a longitudinally extending axis lying substantially in said plane of symmetry. The rotor includes a permanent magnet having magnetic poles on diametrically opposite sides of said axis and soft iron pole pieces fixed to said permanent magnet at the respective magnetic poles thereof, the rotor having a plane of symmetry passing through said magnetic poles and said axis, the soft iron pole pieces extending into close proximity with the inner surfaces of said stator pole sections and the spacing between said permanent magnet and said stator pole sections being substantially greater.

In an embodiment, the cordless oscillatory hand held apparatus comprises a synchronously oscillating A.-C. electric micro-motor having a stator and a rotor cooperating therewith, a rotor shaft mounting said rotor for rotational oscillation, said motor being, mounted in said casing with said rotor shaft extending longitudinally of said casing and through one end thereof. The cordless oscillatory hand held apparatus further comprises elastic means for urging the rotor to a predetermined angular position with respect to the stator, and comprising a brush head outside the casing and attached to the end of the rotor shaft, and said DC/AC converter being arranged to energize said stator with alternating current to produce rotational oscillation of said rotor in synchronism with said alternating current and thereby of said brush head.

In a preferred embodiment, the cordless oscillatory hand held apparatus comprises a DC battery housed in said compartment, the DC battery being rechargeable by induction.

In an embodiment, the residual magnetism of the permanent magnet is higher than 10800 Gauss, typically comprised between 14200 and 14700 Gauss. For instance the permanent magnet can be a neodymium magnet with a grade N52.

In an embodiment, the cordless oscillatory hand held apparatus is a toothbrush wherein said casing forms a handle of the toothbrush. In this case, the toothbrush may comprise a stator having a core comprising a pair of spaced legs extending in a predetermined direction and a core section joining said legs near one end thereof, said rotor being mounted between the other ends of said legs on a rotor shaft extending in said predetermined direction and through said casing. A brush head is located outside said casing and attached to the end of said rotor shaft, the brush head being rotationally oscillable with said rotor.

In another embodiment, the cordless oscillatory hand held apparatus is a massage apparatus for personal care. In this other case, the massage apparatus for personal care can comprise a working head outside said casing and attached to the end of said rotor shaft, said working head being adapted for working contact with the body, and comprising elastic means for urging the rotor to a predetermined angular position with respect to the stator, the DC/AC converter being arranged to energize said stator with alternating current to produce rotational oscillation of the rotor in synchronism with said alternating current and thereby of said working head.

The invention will be more clearly understood from the following description of an embodiment, which is given by way of example only, with reference to the accompanying schematic drawing, in which:

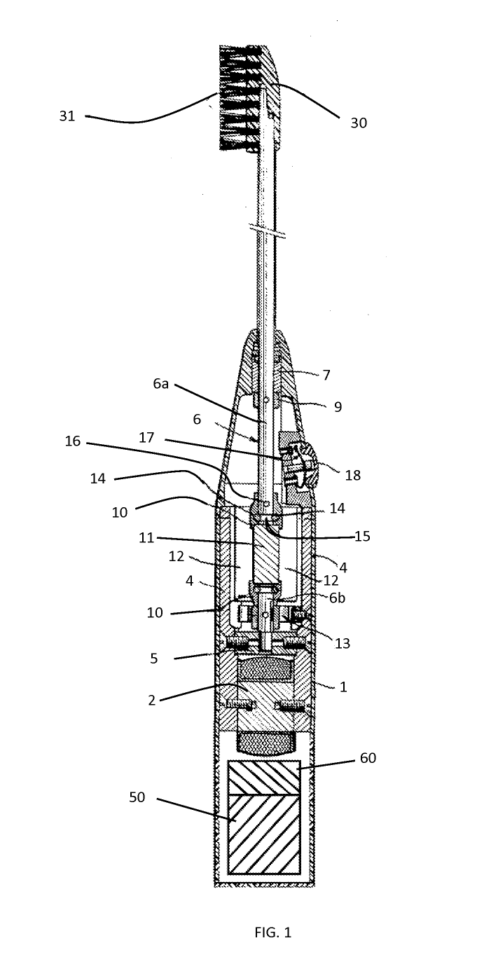

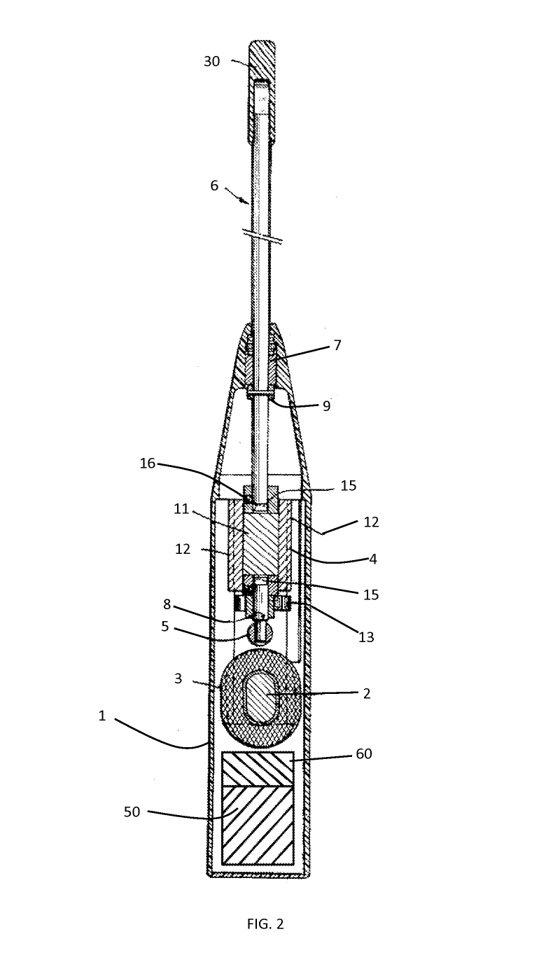

FIGS. 1 and 2 illustrate a complete toothbrush in longitudinal cross-sectional views in two orthogonal planes; and

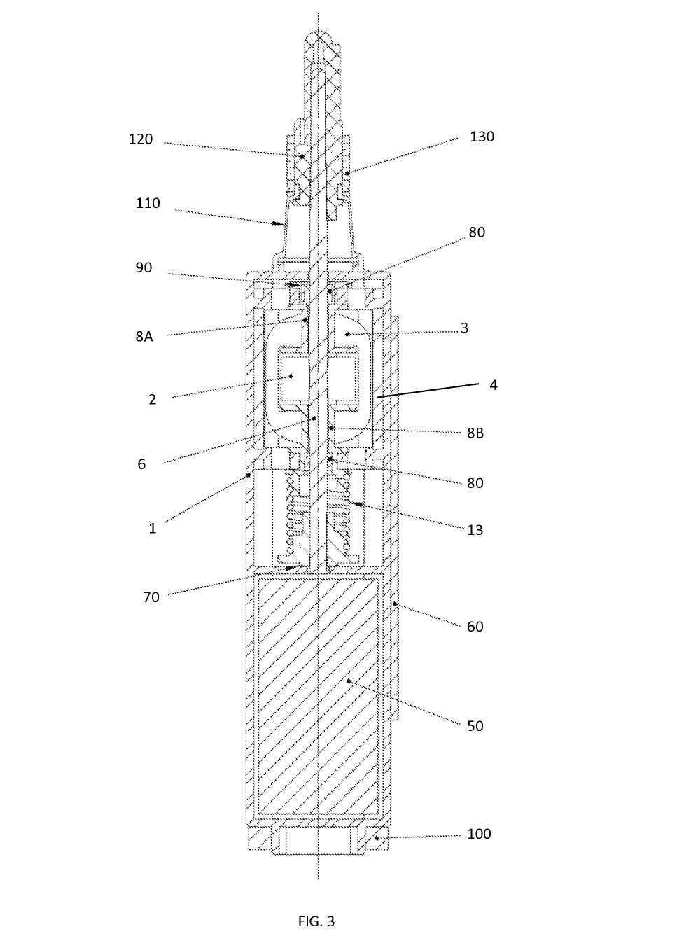

FIG. 3 illustrates a longitudinal cross-sectional view of a cordless hand held apparatus.

The toothbrush illustrated in FIGS. 1 and 2 includes a casing 1 of an approximately elliptic shape made of soft material, for instance, or polyethylene or the like thermoplastic material which hardens upon cooling. Inside said casing forming a handle is fitted without any securing screw an electric micro-motor fed with alternating current and including an oscillable rotor. Said casing, which is a perfectly fluid tight casing, provides complete electrical safety by reason of the elimination of any metal element liable to engage the operator's hand or mucous membranes.

The motor inside the casing 1 includes a stator comprising an electromagnet formed by an oval core 2 arranged perpendicularly to the longitudinal axis of the brush and surrounded by a winding 3, and two pole pieces 4 attached to core 2 and extending longitudinally of the casing 1. An upright 5 (FIG. 1) of non-magnetic material is secured between the pole-pieces 4. A rotor is carried by a steel shaft 6, enclosed if required inside a sheath of soft material, and it includes a permanent magnet 11 and pole-pieces of mild iron 12. Said rotor is urged back into its rest position, by the return spring 13.

The magnetic axis of the rotor magnet 11 is directed perpendicularly to the stator flux when the rotor is in its rest position. Magnet 11 is provided with pole-pieces 12 which are diametrically opposed to each other. Each pole-piece may be considered to consist of two half-sections symmetrically located with reference to the magnetic axis of the magnet 11 and are adapted to form a bridge to either side of the rotor between the pole-pieces 4 of the stator. When an alternating voltage is applied to the stator coil 3, the stator field and the field of the permanent magnet 11 are added to each other in two diametrically opposed half-sections of the pole-pieces 12 and are subtracted from each other in the two other diametrically opposed half-sections, the addition and subtraction alternating between pairs of half-sections in accordance with the changes in direction of the alternating current. The result is that the rotor is subjected to a reciprocating torque which causes it to rock at the frequency of the voltage applied. Since the brush described is to be powered by a DC battery, the DC signal being converted into an AC signal by a DC/AC converter 60, it will vibrate at the frequency of the latter, say 50 to 60 periods per second, typically 55 periods per second, which frequency range has proved during experimentation as the most suitable for the brushing of teeth and for the massaging of gums. In order that the amplitude of the rocking movement of the brush may be as large as possible so as to provide a maximum efficiency of the brush, the moment of inertia of the rotor of the motor and the characteristic properties of its spring 13 are selected in a manner such that the natural mechanical resonant frequency of oscillation of the rotor may be equal to the frequency provided by the DC/AC converter 60.

The upright 5 forms one of the bearings of the shaft 6, the other bearing of which is constituted by the outer end 7 of the casing. A thrust bearing 8 and a ring 9 serve for limiting the axial shifting of the shaft. Said shaft 6 is constituted by two aligned spaced sections 6a and 6b, the ends facing each other carrying jaws 10 made of brass and between which is fitted the permanent rotor magnet 11. Each jaw 10 is secured to the two pole-pieces holding fast between them the magnet, as provided by the two screws 14 passing through the jaws 10 and the pole-pieces 12. Each section of the shaft being secured to the corresponding jaw through a small screw 16. A circumferential groove 15 is provided in each section of the shaft to accommodate screws 14. Thus it is possible to adjust the angular setting of the rotor with reference to the two sections of the shaft 6 before tightening set screws 16. To the inner section 6b is secured one of the ends of the rotor returning coil spring 13, the other end of which is secured to the stator (FIG. 1).

Switch 17 is mounted inside the casing and may be actuated through a control knob 18 fluidtightly fitted inside an opening in the casing wall. This knob is the only outwardly apparent part of the switch, and is constituted by a convex rubber disc secured in an opening of the casing by a force fit engagement of the edge of said opening with an annular groove formed along the periphery of said disc. Said switch allows the user of the brush to start and stop instantaneously the motor through a mere pressure exerted by a finger on the rubber knob 18, whereby the motor circuit is controlled.

The removable brush head 30, provided with bristles 31, is attached to the outer end of the shaft 6 through cooperating oblique planes of corresponding slopes which allow reliably mounting the head on the shaft, said head being also secured to the shaft through the agency of a small locking ball if desired. Said head is made also of soft material similarly to the casing so as to prevent any too harsh shocks on the teeth if the head were to engage the latter instead of the bristles.

The tests to which the above described brush has been subjected have provided excellent results proving its easy handling, its strength and its efficiency. Its structure is designed in a particularly careful manner and leads to important advantages. The result of more than fifty years of research and development has shown that delivering a powerful yet entirely smooth mechanical action through a high intensity perfectly sinusoidal axial oscillatory motion is the best solution for an hand held apparatus. Providing a cordless oscillatory hand held apparatus comprising a casing enclosing a rotationally oscillatory wireless electric micro-motor operable by application of an AC current is the solution that everybody was waiting for.

The toothbrush described above corresponds to that of U.S. Pat. No. 2,917,758 except that in U.S. Pat. No. 2,917,758 the motor was connected to an external mains AC power supply.

The toothbrush according to the invention comprises a compartment for a battery 50 and a DC/AC converter 60. The DC/AC converter 60 is an electronic circuit arranged to transform direct current into alternating current and to energize the stator with alternating current at a frequency in the range of approximately 50 to 60 cycles per second to produce rotational oscillations of the rotor of corresponding frequency.

As shown in FIG. 3, the motor inside the casing 1 includes a metallic shaft 6 integral with a rotor 2 made by two grade N52 magnets 11 over molded on said shaft 6. The rotor 2 has one south pole and one north pole positioned on opposite sides around the shaft 6, and is composed of two sintered neodymium magnets 11 over molded on each side of the shaft 6. The magnetization force is N52 which corresponds to a residual magnetism of the permanent magnet 11 comprised between 14200 and 14700 Gauss. A switch control knob (not illustrated) located outside of the casing 1 of the device, allows controlling reed switches located inside of the casing 1 which together with a system of resistors allows to switch OFF and to switch ON the motor on at least three energy levels [Low-Medium-High] which allows the use of the device according to a well defined posology.

Two coils 3 are disposed around the rotor 2 and are connected in series. In a variant not illustrated, the two coils 3 can be connected in parallel. A static part of the motor is composed of two bearings 8A, 8B energizing coils 3 electrically connected to the DC battery 50. The stator 4 is also used to hold the bearings 8A, 8B the whole being accurately located in the casing 1. A first front bearing 8A is a front guiding support with a brass guiding sleeve 80 and a silent block 90 between each of those two parts. A front and a rear brass guiding sleeve 80 guide the shaft 6 and suppress all parasite noises generated by the oscillatory motion. The silent block 90, in soft plastic material, is over molded between front guiding support and brass guiding sleeve 80. The silent block 90 function is to absorb the misalignment of two precise guiding sleeve 80. A second rear bearing 8B is a rear guiding support with brass guiding sleeve 80 fixed inside. This second rear bearing 8B fixes also a helical spring 13 compared to the main casing 1.

One side of the helical spring 13 is fixed compared to the main body, and the other side is linked to the rotor, to maintain said rotor in neutral position, and create in collaboration with alternative current in the coils, the oscillation with the angle and torque desired. The helical spring 13 has also the function to maintain in axial position the shaft, by compression. The outside end of the shaft 6, extending the casing 1, is driven by the movable part of the oscillating motor which is mainly composed of the recall helical spring 13, a fixation sleeve, an inertial mass 130 allowing to tune the resonance frequency to the frequency of the AC current provided by the DC/AC converter 60. The DC/AC converter 60 is an electronic circuit integrated in printed circuit board attached to one side of the casing 1 and extending from the battery 50 to over the motor.

A friction washer 70 eliminates mechanical wear between fix and oscillating plastic parts, due to the axial compression of the twist spring 13 and oscillation.

The cordless hand held apparatus further comprises a Direct Current Battery 50 which can be for instance a lithium battery, Li-Ion or Li-Polymer, providing 11.1 Vdc or 14.8 Vdc. A charging coil 120 mounted on the end of casing 1 adjacent to the battery 50 allows the battery to be charged by induction, without electric contact.

A rubber protection 110 is used to make the motor completely impervious to water and dust. This rubber protection 110 guarantees the watertightness between the casing 1 and another part fixed on the extending part of the shaft 6. It is evident that one end of the helical biasing spring 13 is fixed to the non movable part of the casing 1.

A shaft tip 120 is a support for external attachments as stembrush or massager attachments. An inertial mass 130 is fixed on the shaft to calibrate the motor performances compared to the wanted oscillation frequency (55 Hz). The inertial mass 130 allows tuning the resonance frequency to the frequency of the AC power supply.

A printed circuit board 60 comprises an electronic circuit to convert direct current in alternating current at 55 Hz.

The present invention combines the advantage of a rocking movement with a cordless apparatus.

1. A cordless oscillatory hand held apparatus, comprising a casing enclosing a rotationally oscillatory wireless electric micro-motor operable by application of an AC current, the micro-motor comprising an electromagnetic stator and a rotor cooperating therewith, said rotor having a rotor shaft extending from the micro-motor through the casing, the casing including a compartment for housing a battery to power said micro-motor to produce rotational oscillation of said rotor and rotor shaft that imparts a rocking movement to the rotor shaft, and further comprising a DC/AC converter for converting DC current from a battery in said compartment into an AC current applied to the electric micro-motor.

2. A cordless oscillatory hand held apparatus according to claim 1, wherein said micro-motor is adapted to oscillate synchronously at the AC frequency applied thereto, said DC/AC converter being arranged to energize said stator with alternating current at a frequency in the range of approximately 50 to 60 cycles per second to produce rotational oscillations of said rotor of corresponding frequency.

3. A cordless oscillatory hand held apparatus according to claim 1, wherein the stator has a core comprising a pair of spaced legs extending longitudinally of said casing and a transverse section joining said legs near one end thereof, said rotor being mounted between the other ends of said legs on a rotor shaft extending longitudinally of said casing, said rotor shaft extending through one end of said casing.

4. A cordless oscillatory hand held apparatus according to claim 3, wherein the other ends of said legs form pole sections substantially symmetrical with respect to a plane therethrough that extends longitudinally of said casing, and further comprising a coil encircling said transverse section, the rotor being positioned between said pole sections, said rotor shaft mounting said rotor for rotation about an axis extending longitudinally of said casing and substantially in said plane of symmetry, said rotor including a permanent magnet having magnetic poles on diametrically opposite sides of said axis and said rotor shaft extending through one end of said casing, and comprising elastic means for urging said rotor to a predetermined angular position in which a plane of substantial symmetry through said magnetic poles and through said axis is approximately perpendicular to said plane of symmetry of the stator pole sections, and said DC/AC converter being arranged to energize said stator coil with alternating current to produce rotational oscillation of said rotor.

5. A cordless oscillatory hand held apparatus according to claim 3, wherein the other ends of said legs form pole sections substantially symmetrical with respect to a plane therethrough extending longitudinally of said casing, the inner surfaces of said pole sections forming portions of a cylindrical surface having a longitudinally extending axis lying substantially in said plane of symmetry, and comprising a coil encircling said transverse section, said rotor being positioned between said pole sections, a rotor shaft mounting said rotor for rotation about said axis and extending through one end of said casing, said rotor including a permanent magnet having magnetic poles on diametrically opposite sides of said axis and soft iron pole pieces fixed to said permanent magnet at the respective magnetic poles thereof, said rotor having a plane of symmetry passing through said magnetic poles and said axis, said soft iron pole pieces extending into close proximity with the inner surfaces of said stator pole sections and the spacing between said permanent magnet and said stator pole sections being substantially greater, and comprising elastic means for urging said rotor to an angular position in which said rotor plane of symmetry is approximately perpendicular to said plane of symmetry of the stator pole sections, and said DC/AC converter being arranged to energize said stator coil with alternating current to produce rotational oscillation of said rotor.

6. A cordless oscillatory hand held apparatus according to claim 1, comprising elastic means for urging said rotor to a predetermined angular position with respect to said stator, and comprising a brush head outside said casing and attached to the end of said rotor shaft, and said DC/AC converter being arranged to energize said stator with alternating current to produce rotational oscillation of said rotor in synchronism with said alternating current and thereby of said brush head.

7. A cordless oscillatory hand held apparatus according to claim 1, comprising a DC battery housed in said compartment, wherein the DC battery is rechargeable by induction.

8. A cordless oscillatory hand held apparatus according to claim 7, further comprising an induction coil for recharging the DC battery, said induction coil being mounted on the casing adjacent to the battery compartment.

9. A cordless oscillatory hand held apparatus according to claim 4, wherein the residual magnetism of the permanent magnet is higher than 10800 Gauss, typically comprised between 14200 and 14700 Gauss.

10. A cordless oscillatory hand held apparatus according to claim 1, which is a toothbrush wherein said casing forms a handle of the toothbrush.

11. A cordless oscillatory hand held apparatus according to claim 10, wherein said stator has a core comprising a pair of spaced legs extending in a predetermined direction and a core section joining said legs near one end thereof, said rotor being mounted between the other ends of said legs on a rotor shaft extending in said predetermined direction and through said casing, a brush head outside said casing and attached to the end of said rotor shaft, the brush head being rotationally oscillable with said rotor.

12. A cordless oscillatory hand held apparatus according to claim 1, which is a massage apparatus for personal care.

13. A cordless oscillatory hand held apparatus according to claim 12, comprising a working head outside said casing and attached to the end of said rotor shaft, said working head being adapted for working contact with the body, and comprising elastic means for urging said rotor to a predetermined angular position with respect to said stator, said DC/AC converter being arranged to energize said stator with alternating current to produce rotational oscillation of said rotor in synchronism with said alternating current and thereby of said working head.

14. A cordless oscillatory hand held apparatus according to claim 1, wherein the DC/AC converter is mounted externally of said casing.

15. A cordless oscillatory hand held apparatus according to claim 1, wherein an inertial mass is connected to the shaft external to the housing for calibrating resonance frequency to the frequency of the AC power supply.
